(19) United States
(12) Patent Application Publication
(10) Pub. No.: US 2010/0023327 A1
(43) Pub. Date: Jan. 28, 2010

(54) METHOD FOR IMPROVING SPEECH SIGNAL NON-LINEAR OVERWEIGHTING GAIN IN WAVELET PACKET TRANSFORM DOMAIN

(75) Inventors: Sung Il Jung, Gyeonggi-do (KR); Young Hun Kwon, Gyeonggi-do (KR); Sung Il Yang, Gyeonggi-do (KR)

Correspondence Address: OCCHIUTI ROHLICEK & TSAO, LLP, 10 FAWCETT STREET, CAMBRIDGE, MA, 02138, US

(73) Assignee: Iucf-Hyu (Industry-University Cooperation Foundation Hanyang University, Seoul (KR)

(21) Appl. No.: 12/515,806

(22) PCT Filed: Nov. 21, 2007
(86) PCT No.: PCT/KR2007/005872

§ 371 Date: May 21, 2009

(30) Foreign Application Priority Data
Nov. 21, 2006 (KR) 10-2006-0115012

(51) Int. Cl. G10L 19/14

(52) U.S. Cl. 704/225; 704/E19.001

(57) ABSTRACT

The present invention relates to speech enhancement accomplished by applying an overweighting gain of a nonlinear structure in a wavelet packet transform domain or a Fourier transform domain. The present invention relates to a method for improving quality of speech signals, which can be applied in a variety of noise-level conditions using noise estimation of the least-square line method and a modified spectral subtraction method having a nonlinear overweighting gain for each sub-band. According to the method for improving quality of speech of the present invention, it is effective in that quality of speech can be further effectively improved in a variety of noise-level conditions. Particularly, according to the present invention, generation of musical tones can be efficiently suppressed, and intelligibility of speech is reliably guaranteed in the improved speech.

### TECHNICAL FIELD

The present invention relates to speech enhancement of noisy speech signals, and more specifically, to a method for improving quality of noisy speech signals by applying a nonlinear overweighting gain by the unit of a sub-band in a wavelet packet transform domain or a Fourier transform domain.

### BACKGROUND ART

In transmitting and receiving speech signals, it is natural that transmitted and received speech signals are corrupted by a noise due to a variety of noise environments at a transmitting end, a receiving end, and a transfer path. In conventional automatic speech processing systems for removing noises from speech signals corrupted by noises, it is highly probable that their performance will be seriously degraded if they are operated in a variety of noise environments. Accordingly, researches are actively in progress recently on improvement of the performance of the automatic speech processing systems by efficiently removing only a noise in the variety of noise environments.

Most of algorithms for speech enhancement in a single channel where noises and speech coexist essentially require noise estimation. A representative algorithm among them is a spectral subtraction method for subtracting an estimated noise from noisy speech.

In speech enhancement procedure such as the spectral subtraction method, accuracy of noise estimation is the most important factor for determining quality of speech improved from noisy speech. Inaccurate noise estimation is a major factor that degrades quality of speech. If estimated noise is lower than pure noise in an actual noisy speech signal, annoying musical tones will be recognized from the improved speech, whereas if the estimated noise is higher than the pure noise, speech distortion will be increased due to noise subtraction processing. Practically, it is very difficult to accurately estimate noises of speech signals corrupted by a variety of non-stationary noises and to obtain improved speech that is free from annoying musical tones and speech distortions.

Hereinafter, as an example of the spectral subtraction method, conventional speech enhancement procedure will be briefly described, in which noises are estimated from noisy speech in a wavelet packet transform domain, and the estimated noise is subtracted by the spectral subtraction method. Here, although only a transform in the wavelet packet transform domain is described, it is apparent to those skilled in the art that the same can be applied in a Fourier transform domain.

1. Uniform Wavelet Packet Transform of a Noisy Speech Signal

Noisy speech signal x(n) is expressed as a sum of clean speech s(n) and additive noise w(n) as shown in Math Figure 1.

x(n)=s(n)+w(n) [Math Figure 1]

Here, n denotes a discrete time index. <10>First, a transform signal is generated from a noisy speech signal through a Uniform Wavelet Packet Transform (UWPT). The transform signal may be expressed as Coefficients of Uniform Wavelet Packet Transform (CUWPT) in the uniform wavelet packet transform domain, and an example of such a UWPT structure is shown in FIG. 1.

Referring to FIG. 1, if the total tree level is K, a level on which wavelet packet transform is not performed is expressed as K, and the number of nodes in this case is assumed to be 1. Depending on the step of applying the wavelet packet transform, the tree level is decreased by 1, and the number of nodes is increased twice as many. Accordingly, the number of nodes at the k^{th} tree level(0≦k≦K) becomes 2^{K-k}. Each node has one or more transform coefficients, and the number of the transform coefficients included in a node is the same for all nodes.

According to an embodiment of the present invention, the transform coefficients included in each node at the k^{th} tree level uses a transform signal generated by a wavelet transform unit. CUWPT X_{i,j}^{k}(m) at the kth tree level for a short time x(n) of noisy speech is expressed as shown in Math Figure 2 [S. Mallat, A wavelet tour of signal processing, 2nd Ed., Academic Press, 1999].

X_{i,j}^{k}(m)=S_{i,j}^{k}(m)+W_{i,j}^{k}(m) [Math Figure 2]

Here, S_{i,j}^{k}(m) is CUWPT of clean speech, and W_{i,j}^{k}(m) is CUWPT of a noise. Then, each of the indexes used in Math Figure 2 is defined as shown below, and these indexes are applied to all Math Figures described in the specification with the same meaning.

i: Frame index

j: Node index (0≦j≦2^{K-k}−1)

K: Depth index of whole tree

k: Tree depth index (0≦k≦K)

m: CUWPT index in node

2. Noise Estimation and Spectral Subtraction

Among speech processing algorithms used for speech enhancement, a spectral magnitude subtraction method in the frequency domain having low calculation amount and high efficiency is widely used to obtain improved speech by subtracting an estimated noise from noisy speech in a single channel where speech and noise coexist [N. Virag, “Single channel speech enhancement based on masking properties of the human auditory system,” IEEE Trans. Speech Audio Processing, vol. 7, pp. 126-137, March 1999.].

The spectral magnitude subtraction method essentially requires noise estimation, and quality of improved speech is determined by accuracy of the noise estimation. Therefore, in a speech enhancement algorithm using the spectral magnitude subtraction method, it is most important to accurately estimate a noise from noisy speech.

A generally used noise estimation method is a first regression method based on statistical information presented by a plurality of noise frames, i.e., bundle frames, extracted by a Voice Activity Detector (VAD), and general noise estimation in the wavelet packet transform domain is expressed as shown in Math Figure 3.

$$\vert {\hat{W}}_{i , j}^{k} ( m ) \vert = \\ \{ \begin{matrix}ɛ \vert {\hat{W}}_{i - 1 , j}^{k} ( m ) \vert + ( 1 - ɛ ) \vert {X}_{i , j}^{k} ( m ) \vert , & if \vert {X}_{i , j}^{k} ( m ) \vert < v \vert {\hat{W}}_{i - 1 , j}^{k} ( m ) \vert \\ \vert {\hat{W}}_{i - 1 , j}^{k} ( m ) \vert , & otherwise\end{matrix} \qquad [ Math Figure 3 ]$$

Here, ε (0.5≦ε≦0.9) and v (v>1) are respectively a forgetting coefficient and a threshold value.

Then, the magnitude spectral subtraction method in the uniform wavelet packet transform is expressed as shown in Math Figure 4.

$${\hat{S}}_{i , j}^{k} ( m ) = \{ \begin{matrix}sign \{ {X}_{i , j}^{k} ( m ) \} ( \begin{matrix}\vert {X}_{i , j}^{k} ( m ) \vert - \\ \vert {W}_{i , j}^{k} ( m ) \vert\end{matrix} ) , & if \vert {X}_{i , j}^{k} ( m ) \vert > v \vert {\hat{W}}_{i , j}^{k} ( m ) \vert \\ 0 , & otherwise\end{matrix} \qquad [ Math Figure 4 ]$$

Here, |X_{i,j}^{k}(m)|, |Ŵ_{i,j}^{k}(m)|, Ŝ_{i,j}^{k}(m) and sign{X_{i,j}^{k}(m)} respectively represent magnitude of CUWPT of noisy speech, magnitude of CUWPT of a noise, CUWPT of improved speech, and sign of X_{i,j}^{k}(m). However, since noise estimation using Math Figure 3 does not take into account a variety of non-stationary noise environments, errors are inevitably occurred in the noise estimation, and as a result, it is disadvantageous in that a considerable amount of musical tone components that degrade quality of speech are still remained in a speech signal improved by Math Figure 4.

3. Spectral Subtraction for Suppressing Musical Tones

The purpose of performing a process for improving quality of speech of a speech signal corrupted by a non-stationary noise is to improve performance of a variety of speech application systems. Since a spectral subtraction-type algorithm has a small calculation amount and is easy to implement, it is widely used for speech enhancement in a single channel where speech and noise coexist. However, tones having random frequencies are still remained in the speech improved by those methods, and thus it is disadvantageous in that the improved speech is corrupted by sensibly annoying musical tones. A spectral noise removing part of a speech application system performs a spectral subtraction process for removing a noise of surrounding environments, i.e., an operation for subtracting estimated noise spectrums from a magnitude spectrum where speech and noise are mixed. At this point, since the noise spectrum has a small amount of irregular variations, although an estimated noise is subtracted from the noisy speech signal, a noise still remains in a specific frequency, and thus musical tones are generated. Such musical tones are a major cause that severely degrades quality of the improved speech.

In order to suppress generation of such musical tones, a variety of methods based on the spectral subtraction-type algorithm has been proposed. Widely known examples of the methods include Wiener filtering [J. S. Lim and A. V. Oppenheim, “Enhancement and band-width compression of noisy speech,” IEEE, vol 67, pp 1586-1604, December 1979.], Over-subtraction of noise and spectral flooring [M. Berouti, R. Schwartz, and J. Makhoul, “Enhancement of speech corrupted by acoustic noise,” IEEE ICASSP-79, pp. 208-211, April 1979.], Minimum mean square error of log-spectral magnitude (MMSE-LSA) [Y. Ephraim and D. Malah, “Speech enhancement using a minimum mean-square error log-spectral magnitude estimator,” IEEE Trans. Acoust., Speech, Signal Processing, vol. ASSP-33, pp. 443-445, April 1985.], MMSE short-time spectral magnitude [“Speech enhancement using a minimum mean-square error short-time spectral magnitude estimator,” IEEE Trans. Acoust., Speech, Signal Processing, vol. ASSP-32, pp. 1109-1121, December 1984.], Over-subtraction based on masking properties of human auditory system [N. Virag, “Single channel speech enhancement based on masking properties of the human auditory system,” IEEE Trans. Speech Audio Processing, vol. 7, pp. 126-137, March 1999.], Soft-decision [R. J. McAulay and M. L. Malpass, “Speech enhancement using a soft-decision noise suppression filter,” IEEE Trans. Acoust., Signal, Signal Processing, vol. ASSP-28, pp. 137-145, April 1980.], and the like.

However, most of these algorithms are particularly disadvantageous in that they do not simultaneously accomplish two effects such that intelligibility of speech is not diminished while musical tones are not introduced at a low signal-to-noise ratio (SNR). As a result, a conventional algorithm cannot efficiently perform speech enhancement. Therefore, anxiously required is a method for improving quality of speech that can efficiently remove a noise, in which generation of musical tones is reliably suppressed even at a low SNR while intelligibility of speech is not diminished.

### DISCLOSURE

### Technical Problem

A nonlinear spectral subtraction based on a time-varying gain function G_{i,j}^{k}(m) that is widely used in the uniform wavelet packet transform domain to suppress generation of musical tones is expressed as shown in Math Figures 5 and 6.

$$\begin{matrix}{G}_{i , j}^{k} ( m ) = \{ \begin{matrix}{( 1 - α {\vert \frac{{\hat{W}}_{i , j}^{k} ( m )}{{X}_{i , j}^{k} ( m )} \vert}^{r} )}^{1 / r} , & if {\vert \frac{{\hat{W}}_{i , j}^{k} ( m )}{{X}_{i , j}^{k} ( m )} \vert}^{r} < \frac{1}{α + β} \\ {( β {\vert \frac{{\hat{W}}_{i , j}^{k} ( m )}{{X}_{i , j}^{k} ( m )} \vert}^{r} )}^{1 / r} , & otherwise\end{matrix} & [ Math Figure 5 ] \\ {\hat{S}}_{i , j}^{k} ( m ) = {X}_{i , j}^{k} ( m ) {G}_{i , j}^{k} ( m ) & [ Math Figure 6 ]\end{matrix}$$

Here, α (α≧1) denotes an over-subtraction coefficient for subtracting a noise more than estimated noise to reduce the peak of a residual noise. In addition, β (0≦β≦1) is for masking the residual noise. Then, γ (γ=1 or γ=2) is an exponent for determining the degree of subtraction curve shape.

However, following problems may be occurred in the speech improved by this method. If a high over-subtraction coefficient is applied to suppress generation of musical tones, intelligibility of speech is lowered due to loss of speech signals. Contrarily, if a low over-subtraction coefficient is applied, a large amount of musical tone components that degrade quality of speech will remain.

Accordingly, in the nonlinear spectral subtraction method based on the time-varying gain function described above, it is most important for speech enhancement to adaptively set an over-subtraction coefficient depending on changes in non-stationary noise environments so that reliability of noise estimation is enhanced and generation of musical tones is efficiently suppressed. The present invention has been made in order to solve the above problems, and it is an object of the invention to provide a method for improving quality of speech, in which quality of speech can be further effectively improved in a variety of noise-level conditions, and particularly, generation of musical tones can be efficiently suppressed, and intelligibility of speech is reliably guaranteed in the improved speech.

### Technical Solution

In order to accomplish the above objects of the invention, according to one aspect of the invention, there is provided a method for improving quality of speech, the method comprising the steps of: (a) generating a transform signal by performing a uniform wavelet packet transform (UWPT) or a Fourier transform on a noisy speech signal; (b) obtaining a relative magnitude difference of each sub-band, which is an identifier for obtaining a relative difference between an amount of noise existing in the sub-band and an amount of noisy speech, by using an estimation noise signal estimated by a least-square line (LSL) method that uses a least-square line extracted from the magnitude of coefficients of the transform signal, together with a transform signal of a frame reconfigured along the least-square line with respect to the noisy speech signal; (c) obtaining the overweighting gain of a nonlinear structure from the relative magnitude difference; (d) obtaining a modified time-varying gain function that is based on a least-square line method, by using the estimation noise signal estimated by the least-square line method, the transform signal of the frame reconfigured along the least-square line, and the overweighting gain of a nonlinear structure; and (e) performing spectral subtraction using the modified time-varying gain function.

Preferably, the relative magnitude difference is defined by Equation E1 shown below.

$${γ}_{i} ( τ ) ≅ 2 \frac{\sqrt{{\sum }_{m = S B τ}^{S B ( τ + 1 )} max ( {\overline{X}}_{i , j}^{k} ( m ) , {\hat{W}}_{i , j}^{k} ( m ) ) {\sum }_{m = S B τ}^{S B ( τ + 1 )} {\hat{W}}_{i , j}^{k} ( m )}}{{\sum }_{m = S B τ}^{S B ( τ + 1 )} max ( {\overline{X}}_{i , j}^{k} ( m ) , {\hat{W}}_{i , j}^{k} ( m ) ) + {\sum }_{m = S B τ}^{S B ( τ + 1 )} {\hat{W}}_{i , j}^{k} ( m )} \qquad ( E 1 )$$

Here, i denotes a frame index, j denotes a node index (0≦j≦2^{K-k}−1), k denotes a tree depth index (0≦k≦K) (K denotes a depth index of a whole tree), m denotes a CUWPT index in a node, SB denotes a sub-band size, τ denotes a sub-band index, γᵢ(τ) denotes a difference of relative magnitude, X_{i,j}^{k}(m) denotes a CUWPT of noisy speech, X̅_{i,j}^{k}(m) denotes a transform coefficient of a frame reconfigured along a least-square line of the noisy speech, and Ŵ_{i,j}^{k}(m) denotes a noise estimated by the least-square line method.

Then, the overweighting gain of the nonlinear structure is defined by Equation E2 shown below.

$${ψ}_{i} ( τ ) = \{ \begin{matrix}{ρ ( \frac{{γ}_{i} ( τ ) - η}{1 - η} )}^{k} , & if {γ}_{i} ( τ ) > η \\ 0 , & otherwise\end{matrix} \qquad ( E 2 )$$

Here, i denotes a frame index, τ denotes a sub-band index, ψᵢ(τ) denotes an overweighting gain, γi(τ) denotes a difference of relative magnitude, η is 2\sqrt{2}/3 meaning that an amount of speech existing in a sub-band is the same as an amount of noise, p is a level coordinator for determining a maximum value of ψᵢ(τ), and k is an exponent for transforming forms of ψᵢ(τ).

In addition, the step of performing spectral subtraction comprises the step of obtaining an improved speech signal shown in Equation E4 using a time-varying gain function shown in Equation E3.

$$\begin{matrix}{G}_{i , j}^{k} ( m ) = \{ \begin{matrix}\sqrt{1 - \frac{( 1 + ψ ( τ ) ) {\hat{W}}_{i , j}^{k} ( m )}{{\overline{X}}_{i , j}^{k} ( m )}} , & if \frac{{\hat{W}}_{i , j}^{k} ( m )}{\overline{{X}_{i , j}^{k}} ( m )} < \frac{1}{1 + ψ ( τ )} \\ β \sqrt{\frac{{\hat{W}}_{i , j}^{k} ( m )}{{\overline{X}}_{i , j}^{k}}} , & otherwise\end{matrix} & ( E 3 ) \\ {\hat{S}}_{i , j}^{k} ( m ) = {X}_{i , j}^{k} ( m ) {G}_{i , j}^{k} ( m ) & ( E 4 )\end{matrix}$$

Here, i denotes a frame index, j denotes a node index (0≦j≦2^{K-k}−1), k denotes a tree depth index (0≦k≦K) (K denotes a depth index of a whole tree), m denotes a CUWPT index in a node, τ denotes a sub-band index, Ŝ_{i,j}^{k}(m) denotes a CUWPT of improved speech, X_{i,j}^{k}(m) denotes a CUWPT of noisy speech, G_{i,j}^{k}(m) denotes a time-varying gain function (0≦G_{i,j}^{k}(m)≦1), ψᵢ(τ) denotes an overweighting gain, X̅_{i,j}^{k}(m) denotes a transform coefficient of a frame reconfigured along a least-square line of the noisy speech, Ŵ_{i,j}^{k}(m) denotes a noise estimated by the least-square line method, and β denotes a spectral flooring factor.

### ADVANTAGEOUS EFFECTS

According to a method for improving quality of speech by applying an overweighting gain of a nonlinear structure in a wavelet packet transform domain or a Fourier transform domain according to an embodiment of the present invention, noise estimation using the least-square line (LSL) algorithm and a modified spectral subtraction method having a nonlinear overweighting gain for each sub-band are used, and thus it is effective in that quality of speech can be further effectively improved in a variety of noise-level conditions (i.e., non-stationary noise environments). Particularly, according to the present invention, generation of musical tones can be efficiently suppressed, and intelligibility of speech is reliably guaranteed in the improved speech.

Furthermore, as described below, in a variety of performance evaluations performed by the inventor, performance of the method for improving quality of speech according to an embodiment of the present invention is observed to be superior to that of a conventional method in a variety of noise-level conditions. Particularly, the method according to an embodiment of the present invention shows a reliable result even at a low signal-to-noise ratio (SNR). Furthermore, since speech enhancement is accomplished without delaying frames in the method for improving quality of speech according to an embodiment of the present invention, the method of the present invention can be applied to almost all automatic speech processing systems, and if the method is applied, performance of a system can be further improved in a variety of noise environments.

### DESCRIPTION OF DRAWINGS

Further objects and advantages of the invention can be more fully understood from the following detailed description taken in conjunction with the accompanying drawings in which:

FIG. 1 is a view showing transform coefficients and a tree structure according to a wavelet packet transform;

FIG. 2 is a view showing change of an overweighting gain with respect to change of a magnitude SNR according to an embodiment of the invention;

FIG. 3 is a view showing a spectrogram of speech corrupted by fighter noise having an SNR of 5 dB and overweighting gains of respective sub-bands measured from the spectrogram;

FIG. 4 shows a graph comparing improved SNRs obtained by the method according to an embodiment of the present invention with SNRs obtained by conventional methods;

FIG. 5 shows a graph comparing improved segmental LARs obtained by the method according to an embodiment of the present invention with segmental LARs obtained by conventional methods;

FIG. 6 shows a graph comparing improved segmental WSSMs obtained by the method according to an embodiment of the present invention with segmental WSSMs obtained by conventional methods; and

FIGS. 7 to 12 are views respectively showing waveforms and spectrograms of improved speeches obtained from a speech signal, which is corrupted by an SNR of 5 dB due to a noise similar to speech, by the method according to an embodiment of the present invention and conventional methods.

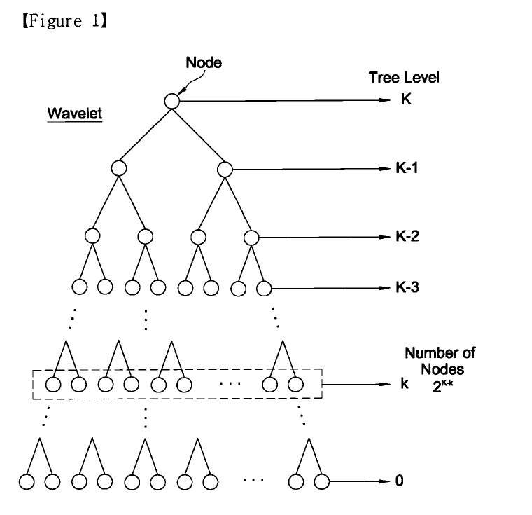

### BEST MODE

Hereinafter, the preferred embodiments of the present invention will be described in detail with reference to the accompanying drawings.

As described above, an object of the present invention is to provide a method for improving quality of speech, which can be reliably performed in a variety of noise environments, and the present invention relates to the method for improving quality of speech signals by applying an overweighting gain of a nonlinear structure in a wavelet packet transform domain or a Fourier transform domain. In the present invention, noise estimation using the least-square line (LSL) algorithm and a modified spectral subtraction method having a nonlinear overweighting gain for each sub-band are used. In the present invention, the overweighting gain is used to suppress generation of sensibly annoying musical tones, and sub-bands are employed to apply different overweighting gains depending on change of a signal.

Such a method for improving quality of speech according to the present invention comprises the steps of (a) generating a transform signal by performing a uniform wavelet packet transform (UWPT) or a Fourier transform on a noisy speech signal; (b) obtaining a relative magnitude difference, which is an identifier for obtaining a relative difference between an amount of noise existing in a sub-band and an amount of noisy speech, by using an estimation noise signal estimated by a least-square line (LSL) method that uses a least-square line extracted from the magnitude of coefficients of the transform signal, together with a transform signal of a frame reconfigured along the least-square line with respect to the noisy speech signal; (c) obtaining the overweighting gain of a nonlinear structure from the relative magnitude difference; (d) obtaining a modified time-varying gain function that is based on a least-square line method, by using the estimation noise signal estimated by the least-square line method, the transform signal of the frame reconfigured along the least-square line, and the overweighting gain of a nonlinear structure; and (e) performing spectral subtraction using the modified time-varying gain function.

Hereinafter, the overweighting gain of a nonlinear structure for suppressing generation of musical tones and the modified spectral subtraction method used in the method for improving quality of speech according to the present invention will be described in detail.

1. Nonlinear Overweighting Gain of Each Sub-Band for Suppressing Generation of Musical Tones

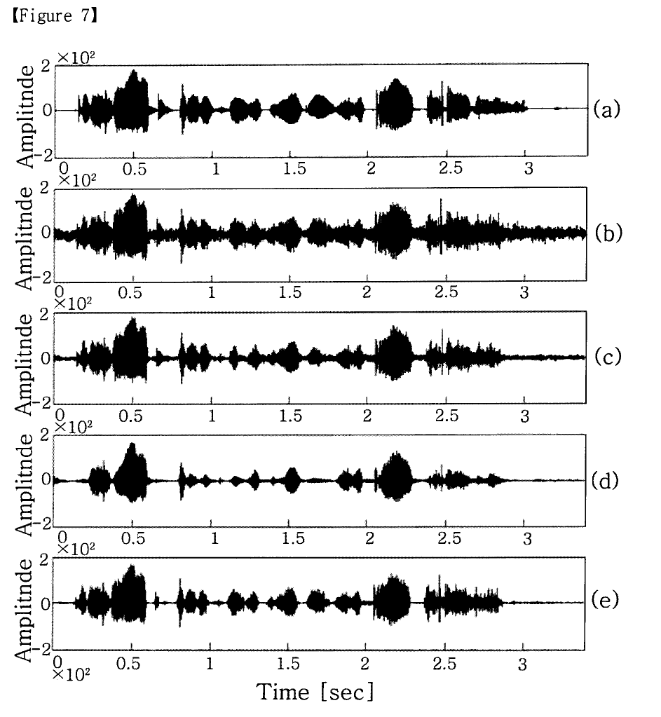

In order properly evaluate an overweighting gain used to suppress generation of musical tones, a relative magnitude difference γᵢ(τ), i.e., an identifier for measuring a relative difference between the amount of noise existing in a sub-band and the amount of noisy speech, is used. Here, the sub-band is configured with a plurality of nodes in a uniform wavelet packet transform [S. Mallat, A wavelet tour of signal processing, 2nd Ed., Academic Press. 1999] domain or a Fourier transform domain, and different values are applied depending on change of a signal. Relative magnitude difference γᵢ(τ) is as shown in Math Figure 7.

$$\begin{matrix}{γ}_{i} ( τ ) = 2 \frac{\sqrt{{\sum }_{m = S B τ}^{S B ( τ + 1 )} \vert {X}_{i , j}^{k} ( m ) \vert {\sum }_{m = S B τ}^{S B ( τ + 1 )} \vert {W}_{i , j}^{k} ( m ) \vert}}{{\sum }_{m = S B τ}^{S B ( τ + 1 )} \vert {X}_{i , j}^{k} ( m ) \vert + {\sum }_{m = S B τ}^{S B ( τ + 1 )} \vert {W}_{i , j}^{k} ( m ) \vert} \\ = \sqrt{1 - {( \frac{{\sum }_{m = S B τ}^{S B ( τ + 1 )} \vert {S}_{i , j}^{k} ( m ) \vert}{{\sum }_{m = S B τ}^{S B ( τ + 1 )} \vert {X}_{i , j}^{k} ( m ) \vert + {\sum }_{m = S B τ}^{S B ( τ + 1 )} \vert {W}_{i , j}^{k} ( m ) \vert} )}^{2}}\end{matrix} \qquad [ Math Figure 7 ]$$

Here, SB denotes the size of a sub-band, which is 2^{p}N obtained by a product of a bunch of nodes 2^{p} (k≦p) divided from nodes 2^{K-k} (K is the depth of the whole tree) and a node size N at a tree depth of k. In addition, τ (0≦τ≦2^{K-p}−1) denotes the index of a sub-band. For example, if γᵢ(τ) is 1, this sub-band is a noise sub-band where

$${\sum }_{m = S B τ}^{S B ( τ + 1 )} \vert {S}_{i , j}^{k} ( m ) \vert = 0 ,$$

and contrarily, if γᵢ(τ) is 0, this sub-band is a speech sub-band where

$${\sum }_{m = S B τ}^{S B ( τ + 1 )} \vert {S}_{i , j}^{k} ( m ) \vert = 0.$$

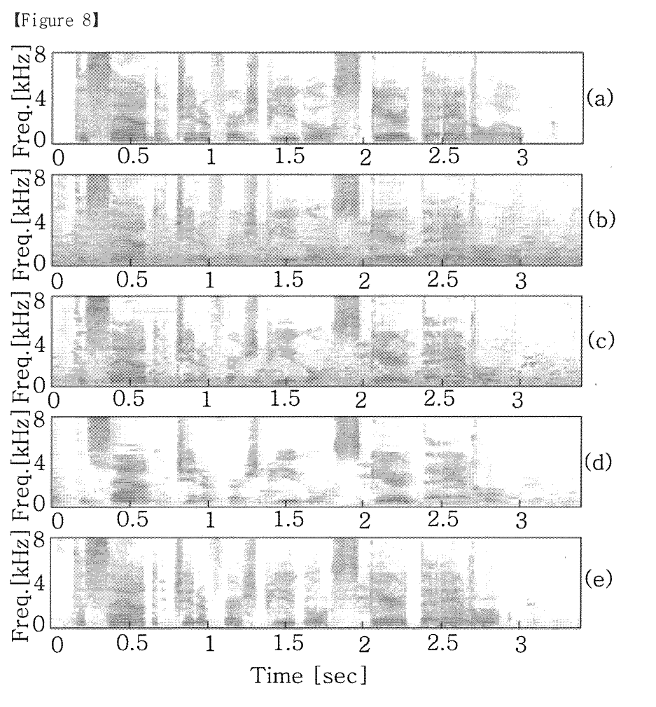

However, it is not easy to accurately estimate a noise from CUWPT X_{i,j}^{k}(m) corrupted by a non-stationary noise in a single channel. Accordingly, it is also difficult to obtain accurate γᵢ(τ). Therefore, in order to overcome such a limitation, the inventor has applied a patent providing a method for estimating a noise based on a least-square line (LSL) X̅_{i,j}^{k}=[ X̅_{i,j}^{k}(0),L, X̅_{i,j}^{k}(N−1)]^{τ} obtained by the least-square method shown in Math Figure 8 [Korea Patent Application No. 2006-11314 (Feb. 6, 2006)], and such a method will be referred to as an LSL method in the present specification.

X̅_{i,j}^{k}=A(A^{T}A)⁻¹A^{T}|X_{i,j}^{k}| [Math Figure 8]

Here, X_{i,j}^{k}=[|X_{i,j}^{k}(0)|,|X_{i,j}^{k}(1)|, . . . ,|X_{i,j}^{k}(N−1)|]^{T}, X̅_{i,j}^{k}(m) and

$$A ( = [ \begin{matrix}1 & 1 \\ 2 & 1 \\ … & … \\ N & 1\end{matrix} ] )$$

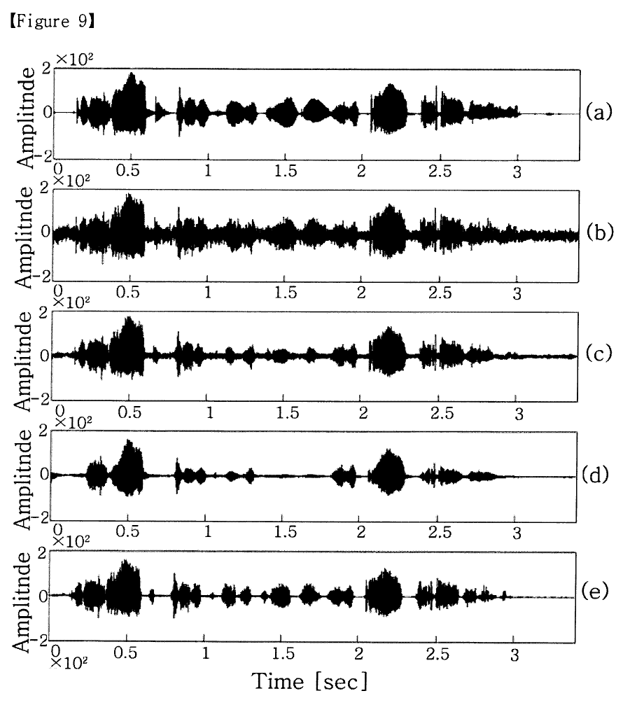

are respectively coefficient magnitudes of uniform wavelet packet node (CMUWPN), LSL coefficients of noisy speech, and an LSL transform matrix of N×2. γi(τ) of Math Figure 7 can be redefined as γi(τ) of Math Figure 9 shown below based on an LSL. Since E[|X_{i,j}^{k}|]=E[|S_{i,j}^{k}|]+E[|W_{i,j}^{k}|] of CMUWPN is the same as E[ X̅_̅{̅i̅,̅j̅}̅^̅{̅k̅}̅]=E[ S̅_̅{̅i̅,̅j̅}̅^̅{̅k̅}̅]+E[ W̅_̅{̅i̅,̅j̅}̅^̅{̅k̅}̅] of the LSL, here, S̅_̅{̅i̅,̅j̅}̅^̅{̅k̅}̅, W̅_̅{̅i̅,̅j̅}̅^̅{̅k̅}̅, and E[·] are respectively an LSL of clean speech, LSL of noise, and expectation value.

$${γ}_{i} ( τ ) = 2 \frac{\sqrt{{\sum }_{m = S B τ}^{S B ( τ + 1 )} {\overline{X}}_{i , j}^{k} ( m ) {\sum }_{m = S B τ}^{S B ( τ + 1 )} {\overline{W}}_{i , j}^{k} ( m )}}{{\sum }_{m = S B τ}^{S B ( τ + 1 )} {\overline{X}}_{i , j}^{k} ( m ) + {\sum }_{m = S B τ}^{S B ( τ + 1 )} {\overline{W}}_{i , j}^{k} ( m )} \qquad [ Math Figure 9 ]$$

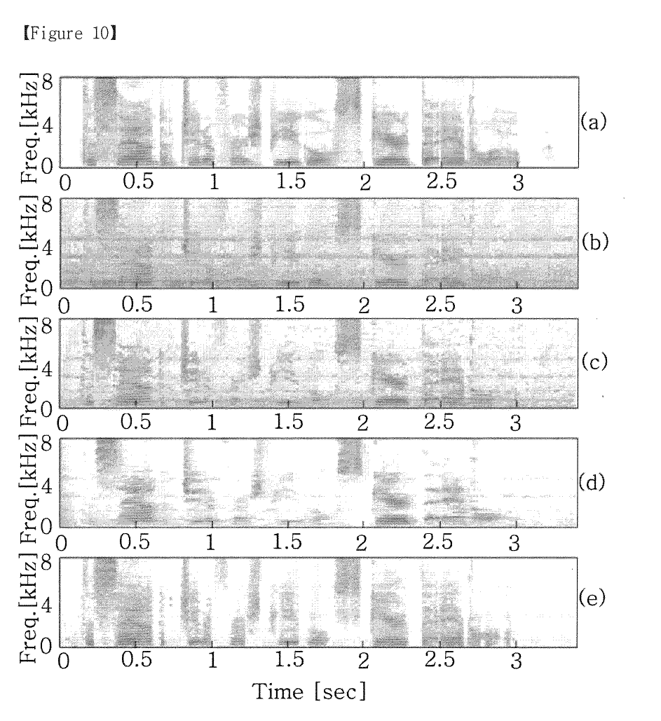

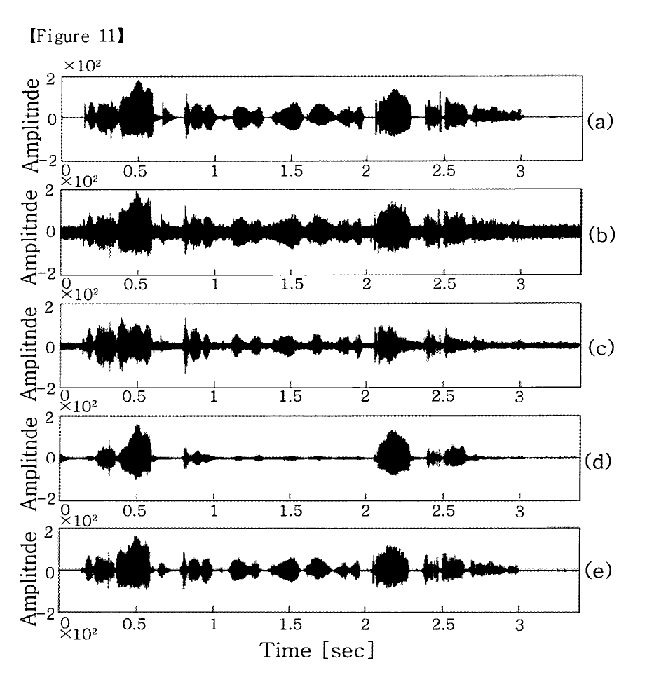

In addition, in order to obtain γᵢ(τ) applied to Math Figure 11, a noise Ŵ_{i,j}^{k}(m) estimated in the LSL method and max( X̅_{i,j}^{k}(m),Ŵ_{i,j}^{k}(m)) are used as shown in Math Figure 10 instead of using W̅_{i,j}^{k}(m) and X̅_{i,j}^{k}(m) of Math Figure 9. Here, since a noise is never higher than an actual signal, max( X̅_{i,j}^{k}(m),Ŵ_{i,j}^{k}(m)) is valid | X̅_{i,j}^{k}(m)|≧|W_{i,j}^{k}(m)|.

As a result, γᵢ(τ) can be expressed as Math Figure 10 shown below.

$${γ}_{i} ( τ ) ≅ 2 \frac{\sqrt{{\sum }_{m = S B τ}^{S B ( τ + 1 )} max ( {\overline{X}}_{i , j}^{k} ( m ) , {\hat{W}}_{i , j}^{k} ( m ) ) {\sum }_{m = S B τ}^{S B ( τ + 1 )} {\hat{W}}_{i , j}^{k} ( m )}}{{\sum }_{m = S B τ}^{S B ( τ + 1 )} max ( {\overline{X}}_{i , j}^{k} ( m ) , {\hat{W}}_{i , j}^{k} ( m ) ) + {\sum }_{m = S B τ}^{S B ( τ + 1 )} {\hat{W}}_{i , j}^{k} ( m )} \qquad [ Math Figure 10 ]$$

In addition, overweighting gain ψᵢ(τ) is defined as shown below in the present invention.

$${ψ}_{i} ( τ ) = \{ \begin{matrix}{ρ ( \frac{{γ}_{i} ( τ ) - η}{1 - η} )}^{k} , & if {γ}_{i} ( τ ) > η \\ 0 , & otherwise\end{matrix} \qquad [ Math Figure 11 ]$$

Here, η is a value of 2\sqrt{2}/3, which is a value meaning that the amount of speech existing in a sub-band is the same as the amount of noise

$$( {\sum }_{m = S B τ}^{S B ( τ + 1 )} \vert {X}_{i , j}^{k} ( m ) \vert = 2 {\sum }_{m = S B τ}^{S B ( τ + 1 )} \vert {W}_{i , j}^{k} ( m ) \vert = 2 {\sum }_{m = S B τ}^{S B ( τ + 1 )} \vert {S}_{i , j}^{k} ( m ) \vert ) ,$$

and p denotes a level coordinator for determining the maximum value of ψᵢ(τ). In addition, k denotes an exponent for transforming forms of ψᵢ(τ).

2. Spectral Subtraction Method Modified for Speech Enhancement

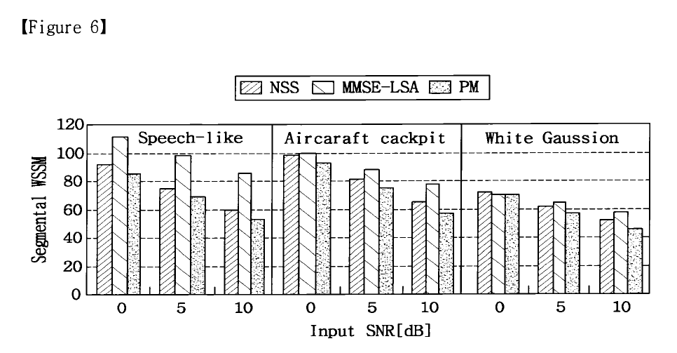

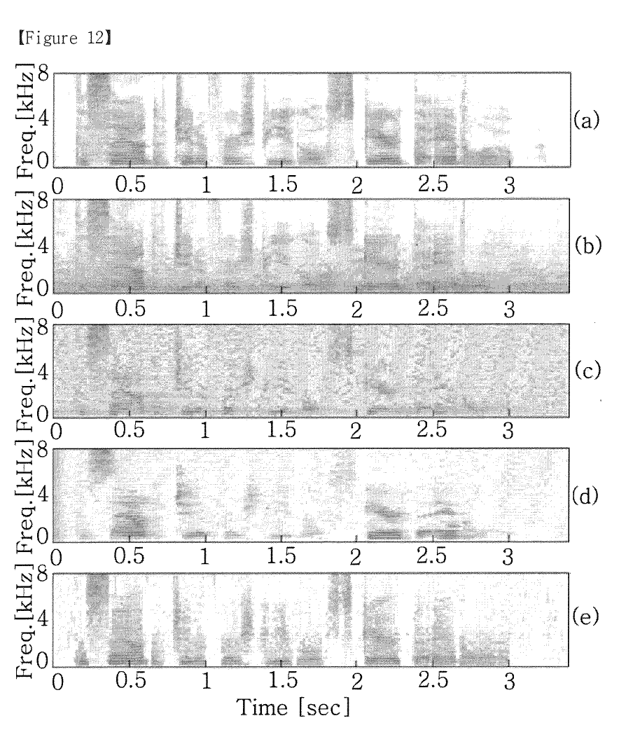

In order to obtain CUWPT Ŝ_{i,j}^{k}(m) of improved speech, a modified time-varying gain function based on an LSL is used as shown in Math Figures 12 and 13 in the present invention, instead of using a conventional spectral subtraction method, i.e., G_{i,j}^{k}(m) shown in Math Figures 5 and 6.

$$\begin{matrix}{G}_{i , j}^{k} ( m ) = \{ \begin{matrix}\sqrt{1 - \frac{( 1 + ψ ( τ ) ) {\hat{W}}_{i , j}^{k} ( m )}{{\overline{X}}_{i , j}^{k} ( m )} ,} & if \frac{{\hat{W}}_{i , j}^{k} ( m )}{\overline{{X}_{i , j}^{k}} ( m )} < \frac{1}{1 + ψ ( τ )} \\ β \sqrt{\frac{{\hat{W}}_{i , j}^{k} ( m )}{{\overline{X}}_{i , j}^{k}}} , & otherwise\end{matrix} & [ Math Figure 12 ] \\ {\hat{S}}_{i , j}^{k} ( m ) = {X}_{i , j}^{k} ( m ) {G}_{i , j}^{k} ( m ) & [ Math Figure 13 ]\end{matrix}$$

Here, G_{i,j}^{k}(m) (0≦G_{i,j}^{k}(m)≦1) and β are respectively a modified time-varying gain function and a spectral flooring factor.

In this manner, an improved overweighting gain of a nonlinear structure and a modified spectral subtraction method described above are used in the present invention, and thus generation of musical tones can be further effectively suppressed.

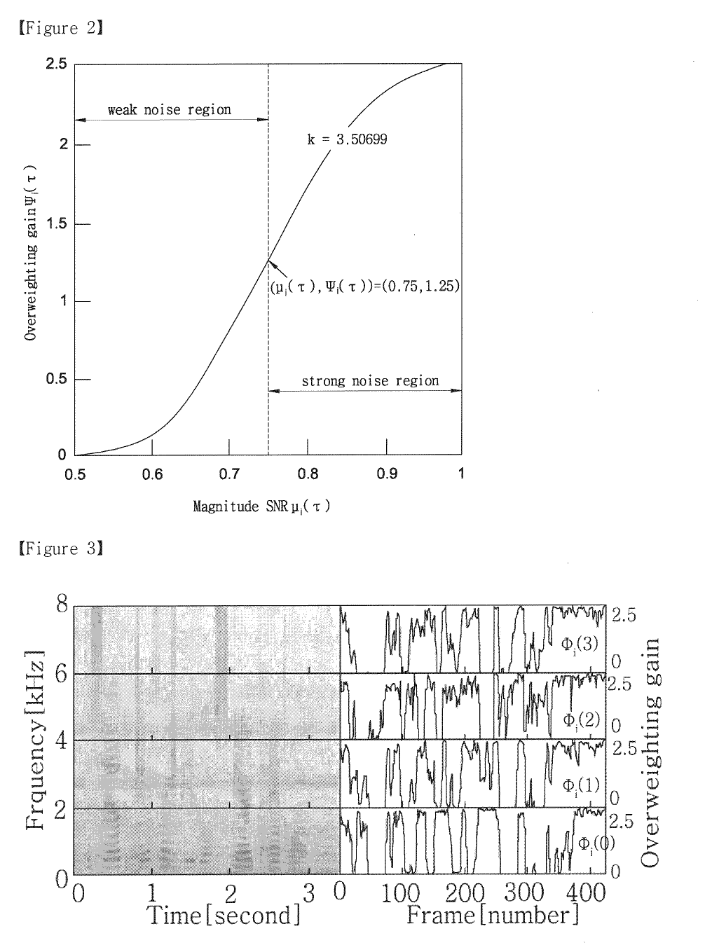

FIG. 2 is a view showing change of overweighting gain ψᵢ(τ) (the thick solid line) with respect to change of magnitude SNR

$${μ}_{i} ( τ ) ( = \frac{{\sum }_{m = S B τ}^{S B ( τ + 1 )} \vert {W}_{i , j}^{k} ( m ) \vert}{{\sum }_{m = S B τ}^{S B ( τ + 1 )} \vert {X}_{i , j}^{k} ( m ) \vert} )$$

where γᵢ(τ)>η and p=2.5. In FIG. 2, the vertical dotted line is a reference line for dividing a weak noise region and a strong noise region.

$$k = 3.50699$$

$$( ≅ \frac{log ( 0.5 )}{log ( 0.820659 … )} )$$

is a value for positioning ψᵢ(τ)=1.25 and μᵢ(τ)=0.75 at the same point, and 0.5 and 0.820659 . . . respectively mean a middle point in the magnitude SNR region and ψᵢ(τ) where μᵢ(τ)=0.75 and k=1.

Here, it should be noted that ψᵢ(τ) has a nonlinear structure. Such ψᵢ(τ) has two major advantages described below.

1) Generation of musical tones can be effectively suppressed in the strong noise region of 0.75<μᵢ(τ)≦1 where the musical tones are frequently generated and more or less strongly recognized compared with the other region. The reason is that since G_{i,j}^{k}(m) in the strong noise region is lower than that of the other region, the amount of noise in the strong noise region is diminished relatively more than the other region.

2) Intelligibility of speech can be reliably provided in the weak noise region of 0.5<μᵢ(τ)≦0.75 where the musical tones are less frequently generated and more or less weakly recognized compared with the other region. The reason is that since G_{i,j}^{k}(m) in the weak noise region is higher than that of the other region, speech information in the weak noise region is diminished relatively less than the other region.

FIG. 3 is a view showing a spectrogram of speech corrupted by fighter noise having an SNR of 5 dB and overweighting gains ψᵢ(τ) of respective sub-bands measured from the spectrogram. It is observed that appropriately expresses characteristics of speech depending on change of noisy speech.

Although an embodiment of the present invention to which a wavelet packet transform is applied is mainly described above, it is apparent to those skilled in the art that the embodiment of the present invention described above can be equivalently applied when a Fourier transform is applied.

[Performance Evaluation]

1. Conditions for Experiment

Hereinafter, the inventor has performed a variety of speech quality evaluation methods in order to observe the effects of the method for improving quality of speech according to the present invention using the overweighting gain of a nonlinear structure and the modified spectral subtraction method described above, and they are described below.

For performance evaluation of the present invention, performance of the method of the present invention is compared with performance of the MMSE-LSA (Minimum Mean Square Error-Log Spectral Magnitude) method proposed by Y. Ephraim [Y. Ephraim and D. Malah, “Speech enhancement using a minimum mean-square error log-spectral magnitude estimator,” IEEE Trans. Acoust., Speech, Signal Processing, vol. ASSP-33, pp. 443-445, April 1985.] and performance of the Nonlinear Spectral Subtraction (NSS) method introduced by M. Berouti [M. Berouti, R. Schwartz, and J. Makhoul, “Enhancement of speech corrupted by acoustic noise,” IEEE ICASSP-79, pp. 208-211, April 1979.].

For the performance evaluation, an improved Segmental SNR (Seg·SNRImp), Segmental LAR (Seg·LAR), Segmental WSSM (Seg·WSSM), and analysis of the waveform and the spectrogram of improved speech are used.

For the experiment, twenty speech signals of ten men and ten women are selected from the TIMIT speech database, and three types of noises, i.e., aircraft cockpit noise, speech-like noise, and white Gaussian noise, are extracted from NoiseX-92. Then, a speech corrupted by an SNR of −5 to 5 dB based on the extracted speeches and noises is used.

2. Performance Evaluation Using a Variety of Methods

Improved Segmental Signal to Noise Ratio (Seg·SNRImp)

In order to measure the degree of SNR improvement of the improved speech, the most generally used Seg·SNR [J. R. Deller, J. G. Proakis, and J. H. L. Hansen, Discrete-time processing of speech signals, Englewood Cliffs, N.J.: Prentice-Hall, 1993.] is used, and improved Seg·SNR (Seg·SNRImp) that is obtained by subtracting Seg·SNRInput of noisy speech from Seg·SNROutput of the improved speech is measured. Seg·SNR is defined as shown in Math Figure 14, and Seg·SNRImp is defined as shown in Math Figure 15.

$$\begin{matrix}Seg \cdot S N R = \frac{1}{F} {\sum }_{i = 0}^{F - 1} 10 log \frac{{\sum }_{n = 0}^{L - 1} {s}^{2} ( iL + n )}{{\sum }_{n = 0}^{L - 1} {[ \hat{s} ( iL + n ) - s ( iL + n ) ]}^{2}} & [ Math Figure 14 ] \\ Seg \cdot S N {R}_{Imp} = Seg \cdot S N {R}_{Output} - Seg \cdot S N {R}_{Input} & [ Math Figure 15 ]\end{matrix}$$

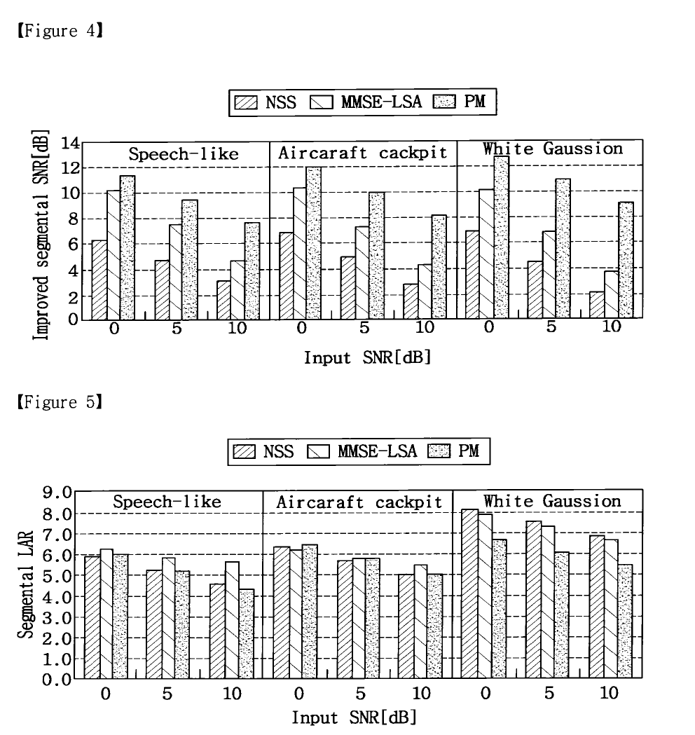

Here, Seg·SNROutput and Seg·SNRInput are respectively Seg·SNR of the improved speech and Seg·SNR of the noisy speech. FIG. 4 shows Seg·SNRImps obtained by the method of the present invention and the compared methods. As shown in FIG. 4, it is observed from the total average Seg·SNRImp that the method of the present invention demonstrates relatively higher performance as much as the differences of 5.43 dB and 2.91 dB compared with the NSS and MMSE-LSA methods. Additionally, in order to further conveniently distinguish Seg·SNRImp performances of the method of the present invention and the compared methods, the total average and averages of respective noises are shown in Table 1.

TABLE 1

| | NSS | MMSE-LSA | PM |
|---|---|---|---|
| Speech-like | 4.68 | 7.39 | 9.38 |
| Aircraft cockpit | 4.85 | 7.28 | 10.02 |
| White Gaussian | 4.45 | 6.84 | 10.85 |
| Total average | 4.66 | 7.17 | 10.09 |

Segmental Log Area Ratio (Seg·LAR)

Among speech evaluations using Linear Predictive Coding (LPC), the Seg·LAR [J. R. Deller, J. G. Proakis, and J. H. L. Hansen] showing the highest correlation with subjective speech quality evaluation is measured. An LAR (Log Area Ratio) is defined as Math Figure 16 shown below.

$$L A R = \frac{1}{F} {\sum }_{i = 0}^{F - 1} \sqrt{\frac{1}{P} {\sum }_{l = 0}^{P - 1} {( \begin{matrix}log \frac{1 + {ρ}_{s ( n )} ( l )}{1 - {ρ}_{s ( n )} ( l )} - \\ log \frac{1 + {ρ}_{\hat{s} ( n )} ( l )}{1 - {ρ}_{\hat{s} ( n )} ( l )}\end{matrix} )}^{2}} \qquad [ Math Figure 16 ]$$

Here, P is the degree of total LPC coefficient. pₛ₍ₙ₎(l) is the LPC coefficient of clean speech, and p_{ŝ(n)}(l) the LPC coefficient of the improved speech. FIG. 5 shows Seg·LARs obtained by the method of the present invention and the compared methods. As shown in FIG. 5, it is observed from the total average Seg·LAR that the method of the present invention demonstrates relatively higher performance as much as the differences of 0.472 dB and 0.663 dB compared with the NSS and MMSE-LSA methods. Additionally, in order to further conveniently distinguish Seg·LAR performances of the method of the present invention and the compared methods, the total average and averages of respective noises are shown in Table 2.

TABLE 2

| | NSS | MMSE-LSA | PM |
|---|---|---|---|
| Speech-like | 5.197 | 5.873 | 5.152 |
| Aircraft cockpit | 5.675 | 5.770 | 5.726 |
| White Gaussian | 7.479 | 7.281 | 6.058 |
| Total average | 6.117 | 6.308 | 5.645 |

Segmental Weighted Spectral Measure (Seg·WSSM)

Among a variety of objective speech evaluations, the Seg·WSSM based on an auditory model [J. R. Deller, J. G. Proakis, and J. H. L. Hansen] showing the highest correlation with subjective speech quality evaluation is measured. A WSSM (Weighted Spectral Slope Measure) is defined as Math Figure 17 shown below.

$$W S S M = \frac{1}{F} {\sum }_{i = 0}^{F - 1} {M}_{SPL} ( M - \hat{M} ) + {\sum }_{q = 0}^{CB - 1} {Γ}_{i} ( q ) \{ {S}_{i} ( q ) - {\hat{S}}_{i} ( q ) \} \qquad [ Math Figure 17 ]$$

Here, M and \hat{M} respectively denote the Sound Pressure Level (SPL) of clean speech and the SPL of improved speech. MSPL denotes a variable coefficient for adjusting overall performance, and Γᵢ(q) is a weighting value of each critical band. CB denotes the number of critical bands. FIG. 6 shows Seg·WSSMs obtained by the method of the present invention and the compared method. As shown in FIG. 6, it is observed from the total average Seg·WSSM that the method of the present invention demonstrates relatively higher performance as much as the differences of 5.7 dB and 16.8 dB compared with the NSS and MMSE-LSA methods. Additionally, in order to further conveniently distinguish Seg·WSSM performances of the method of the present invention and the compared methods, the total average and averages of respective noises are shown in Table 3.

TABLE 3

| | NSS | MMSE-LSA | PM |
|---|---|---|---|
| Speech-like | 75.2 | 98.7 | 68.6 |
| Aircraft cockpit | 81.0 | 88.3 | 74.6 |
| White Gaussian | 61.4 | 63.9 | 57.2 |
| Total average | 72.5 | 83.6 | 66.8 |

Analysis of Waveform of Improved Speech and Spectrogram

Another method of evaluating quality of improved speech is to analyze the waveform and the spectrogram of the speech. This method is useful to determine the degree of attenuation of a speech signal and the degree of residual musical tones from the improved speech. FIGS. 7 to 12 are views showing waveforms and spectrograms of improved speeches obtained from a speech signal, which is corrupted by an SNR of 5 dB due to a noise similar to speech, by the method according to an embodiment of the present invention and the compared methods. It can be confirmed from these figures that the method of the present invention demonstrates further natural speech waveforms and spectrograms compared with those of the compared methods. Furthermore, it can be confirmed that the speech improved by the method of the present invention has further higher intelligibility and less musical tones compared with those of the other methods.

FIG. 7 is a view showing speech waveforms, in which FIG. 7(a) shows the waveform of clean speech, FIG. 7(b) shows the waveform of speech corrupted by an SNR of 5 dB by a noise such as speech, FIG. 7(c) shows the waveform of speech improved from the speech of FIG. 7(b) by the NSS method, FIG. 7(d) shows the waveform of speech improved from the speech of FIG. 7(b) by the MMSE-LSA method, and FIG. 7(e) shows the waveform of speech improved from the speech of FIG. 7(b) by the method of the present invention. Referring to FIG. 7(e), it can be confirmed that the waveform of the speech improved by the method of the present invention is quite similar to the waveform of the clean speech compared with the waveforms of FIGS. 7(c) and 7(d).

FIG. 8 shows a view comparing spectrograms of the speech improved from noisy speech by the method of the present invention and the compared methods. FIG. 8(a) shows the spectrogram of clean speech, FIG. 8(b) shows the spectrogram of speech corrupted by an SNR of 5 dB by a noise such as speech, FIG. 8(c) shows the spectrogram of speech improved from the speech of FIG. 8(b) by the NSS method, FIG. 8(d) shows the spectrogram of speech improved from the speech of FIG. 8(b) by the MMSE-LSA method, and FIG. 8(e) shows the spectrogram of speech improved from the speech of FIG. 8(b) by the method of the present invention. Referring to FIG. 8(e), it can be confirmed that the speech improved by the method of the present invention has further higher intelligibility and less musical tones compared with the results of the compared methods shown in FIGS. 8(c) and 8(d).

On the other hand, FIG. 9 is a view showing speech waveforms, in which FIG. 9(a) shows the waveform of clean speech, FIG. 9(b) shows the waveform of speech corrupted by an SNR of 5 dB by fighter noise, FIG. 9(c) shows the waveform of speech improved from the speech of FIG. 9(b) by the NSS method, FIG. 9(d) shows the waveform of speech improved from the speech of FIG. 9(b) by the MMSE-LSA method, and FIG. 9(e) shows the waveform of speech improved from the speech of FIG. 9(b) by the method of the present invention. Referring to FIG. 9(e), it can be confirmed that the waveform of the speech improved by the method of the present invention is quite similar to the waveform of the clean speech compared with the waveforms of FIGS. 9(c) and 9(d).

FIG. 10 shows a view comparing spectrograms of the speech improved from noisy speech by the method of the present invention and the compared methods. FIG. 10(a) shows the spectrogram of clean speech, FIG. 10(b) shows the spectrogram of speech corrupted by an SNR of 5 dB by fighter noise, FIG. 10(c) shows the spectrogram of speech improved from the speech of FIG. 10(b) by the NSS method, FIG. 10(d) shows the spectrogram of speech improved from the speech of FIG. 10(b) by the MMSE-LSA method, and FIG. 10(e) shows the spectrogram of speech improved from the speech of FIG. 10(b) by the method of the present invention. Referring to FIG. 10(e), it can be confirmed that the speech improved by the method of the present invention has further higher intelligibility and less musical tones compared with the results of the compared methods shown in FIGS. 10(c) and 10(d).

FIG. 11 is a view showing speech waveforms, in which FIG. 11(a) shows the waveform of clean speech, FIG. 11(b) shows the waveform of speech corrupted by an SNR of 5 dB by white Gaussian noise, FIG. 11(c) shows the waveform of speech improved from the speech of FIG. 11(b) by the NSS method, FIG. 11(d) shows the waveform of speech improved from the speech of FIG. 11(b) by the MMSE-LSA method, and FIG. 11(e) shows the waveform of speech improved from the speech of FIG. 11(b) by the method of the present invention. Referring to FIG. 11(e), it can be confirmed that the waveform of the speech improved by the method of the present invention is quite similar to the waveform of the clean speech compared with the waveforms of FIGS. 11(c) and 11(d).

FIG. 12 shows a view comparing spectrograms of the speech improved from noisy speech by the method of the present invention and the compared methods. FIG. 12(a) shows the spectrogram of clean speech, FIG. 12(b) shows the spectrogram of speech corrupted by an SNR of 5 dB by white Gaussian noise, FIG. 12(c) shows the spectrogram of speech improved from the speech of FIG. 12(b) by the NSS method, FIG. 12(d) shows the spectrogram of speech improved from the speech of FIG. 12(b) by the MMSE-LSA method, and FIG. 12(e) shows the spectrogram of speech improved from the speech of FIG. 12(b) by the method of the present invention. Referring to FIG. 12(e), it can be confirmed that the speech improved by the method of the present invention has further higher intelligibility and less musical tones compared with the results of the compared methods shown in FIGS. 12(c) and 12(d).

### INDUSTRIAL APPLICABILITY

The present invention can be effectively used for a noisy speech processing apparatus and method or the like, such as a communication device for video communications, which removes a background noise from noisy speech signals, i.e., speech signals mixed with a noise, and processes only the speech signals.

Although the present invention has been described with reference to several preferred embodiments, the description is illustrative of the invention and is not to be construed as limiting the invention. Various modifications and variations may occur to those skilled in the art, without departing from the scope of the invention as defined by the appended claims.

1. A method for improving quality of speech by applying a nonlinear overweighting gain in a wavelet packet transform domain, the method comprising the steps of:
(a) generating a transform signal comprising coefficients of uniform wavelet packet transform (CUWPT) by performing a uniform wavelet packet transform (UWPT) on a noisy speech signal;
(b) obtaining a relative magnitude difference, which is an identifier for obtaining a relative difference between an amount of noise existing in a sub-band and an amount of noisy speech, by using an estimation noise signal estimated by a least-square line (LSL) method that uses a least-square line extracted from the magnitude of the coefficients of uniform wavelet packet transform (CUWPT), together with a transform signal of a frame reconfigured along the least-square line with respect to the noisy speech signal;
(c) obtaining the nonlinear overweighting gain structure from the relative magnitude difference;
(d) obtaining a modified time-varying gain function that is based on a least-square line method, by using the estimation noise signal estimated by the least-square line method, the transform signal of the frame reconfigured along the least-square line, and the nonlinear overweighting gain; and
(e) performing spectral subtraction using the modified time-varying gain function.

2. The method according to claim 1, wherein the relative magnitude difference is defined by equation E1,
$${γ}_{i} ( τ ) ≅ 2 \frac{\sqrt{{\sum }_{m = S B τ}^{S B ( τ + 1 )} max ( {\overline{X}}_{i , j}^{k} ( m ) , {\hat{W}}_{i , j}^{k} ( m ) ) {\sum }_{m = S B τ}^{S B ( τ + 1 )} {\hat{W}}_{i , j}^{k} ( m )}}{{\sum }_{m = S B τ}^{S B ( τ + 1 )} max ( {\overline{X}}_{i , j}^{k} ( m ) , {\hat{W}}_{i , j}^{k} ( m ) ) + {\sum }_{m = S B τ}^{S B ( τ + 1 )} {\hat{W}}_{i , j}^{k} ( m )} \qquad ( E 1 )$$
wherein i denotes a frame index, j denotes a node index (0≦j≦2^{K-k}−1), k denotes a tree depth index (0≦k≦K) (K denotes a depth index of a whole tree), m denotes a CUWPT index in a node, SB denotes a sub-band size, τ denotes a sub-band index, γᵢ(τ) denotes a difference of relative magnitude, X_{i,j}^{k}(m) denotes a CUWPT of noisy speech, X̅_{i,j}^{k}(m) denotes a transform coefficient of a frame reconfigured along a least-square line of the noisy speech, Ŵ_{i,j}^{k}(m) and denotes a noise estimated by the least-square line method.

3. The method according to claim 1, wherein the nonlinear overweighting gain is defined by Equation E2,
$${ψ}_{i} ( τ ) = \{ \begin{matrix}{ρ ( \frac{{γ}_{i} ( τ ) - η}{1 - η} )}^{k} , & if {γ}_{i} ( τ ) > η \\ 0 , & otherwise\end{matrix} \qquad ( E 2 )$$
where i denotes a frame index, τ denotes a sub-band index, ψᵢ(τ) denotes an overweighting gain, γᵢ(τ) denotes a difference of relative magnitude, η is 2\sqrt{2}/3 meaning that an amount of speech existing in a sub-band is the same as an amount of noise, p is a level coordinator for determining a maximum value of ψᵢ(τ), and k is an exponent for transforming forms of ψᵢ(τ).

4. The method according to claim 1, wherein the step of performing spectral subtraction comprises the step of obtaining an improved speech signal shown in Equation E4 using a time-varying gain function shown in Equation E3,
$$\begin{matrix}{G}_{i , j}^{k} ( m ) = \{ \begin{matrix}\sqrt{1 - \frac{( 1 + ψ ( τ ) ) {\hat{W}}_{i , j}^{k} ( m )}{{\overline{X}}_{i , j}^{k} ( m )} ,} & if \frac{{\hat{W}}_{i , j}^{k} ( m )}{\overline{{X}_{i , j}^{k}} ( m )} < \frac{1}{1 + ψ ( τ )} \\ β \sqrt{\frac{{\hat{W}}_{i , j}^{k} ( m )}{{\overline{X}}_{i , j}^{k}}} , & otherwise\end{matrix} & ( E 3 ) \\ {\hat{S}}_{i , j}^{k} ( m ) = {X}_{i , j}^{k} ( m ) {G}_{i , j}^{k} ( m ) & ( E 4 )\end{matrix}$$
Here, i denotes a frame index, j denotes a node index (0≦j≦2^{K-k}−1), k denotes a tree depth index (0≦k≦K) (K denotes a depth index of a whole tree), m denotes a CUWPT index in a node, τ denotes a sub-band index, Ŝ_{i,j}^{k}(m) denotes a CUWPT of improved speech, X_{i,j}^{k}(m) denotes a CUWPT of noisy speech, G_{i,j}^{k}(m) denotes a time-varying gain function (0≦G_{i,j}^{k}(m)≦1), ψᵢ(τ) denotes an overweighting gain, X̅_{i,j}^{k}(m) denotes a transform coefficient of a frame reconfigured along a least-square line of the noisy speech, Ŵ_{i,j}^{k}(m) denotes a noise estimated by the least-square line method, and β denotes a spectral flooring factor.
